(19) United States
(12) Patent Application Publication
(10) Pub. No.: US 2008/0294490 A1
(43) Pub. Date: Nov. 27, 2008

(54) Networking Platform For Facilitating Interactions And Sharing Of Caretaking Responsibilities Between Family Members

(76) Inventors: Laura Nuhaan, Portola Valley, CA (US); Inger Rarick, Portola Valley, CA (US)

Correspondence Address: PERKINS COIE LLP, P.O. BOX 1208, SEATTLE, WA, 98111-1208, US

(21) Appl. No.: 11/874,783

(22) Filed: Oct. 18, 2007

Related U.S. Application Data
(60) Provisional application No. 60/939,800, filed on May 23, 2007.

(51) Int. Cl. G06Q 10/00

(52) U.S. Cl. 705/9

(57) ABSTRACT

Systems and methods of a networking platform for facilitating interactions and sharing of caretaking responsibilities between family members are described in this application. In one aspect, embodiments of the present disclosure include a method, which may be implemented on a system, of managing a set of calendar events of the care receiver, the set of calendar events of the care receiver to be submitted by one or more of the care receiver a caregiver. One embodiment can include, generating a reminder associated with an upcoming occurrence of a calendar event of the set of calendar events at a predetermined amount of time prior to the upcoming occurrence, the reminder to be provided to one or more caregivers, updating a status of one or more of the set of calendar events based on an update provided by one or more of the care receiver the caregiver, identifying the schedules of the one or more care givers, and/or identifying at least one responsible caregiver to manage a calendar event of the care receiver by comparing the schedules of the one or more care givers with the set of calendar events.

### CLAIM OF PRIORITY

This application claims priority to U.S. Patent Application No. 60/939,800 entitled “Systems, Methods and Apparatus for Connecting Caregivers and Care Recipients”, which was filed on May 23, 2007, the contents of which are expressly incorporated by reference herein.

### TECHNICAL FIELD

The present disclosure relates generally to web-based networking, and in particular to applications of facilitating interactions between an elderly and caregivers, via a web-interface.

### BACKGROUND

As life expectancy increases globally, the elderly population around the world is also sharply rising. For example, in 2005 in the United States the population age sixty-five and over was approximately 36 million which is expected to grow to 86 million in 2050. The elderly may live alone or with another aged partner. Oftentimes, the children of the elderly and other family members of the elderly live in a different residence, sometimes in another state, or another country. The geographic separation of family members has increased the difficulty for providing the elderly with needed care. For example, many elderly individuals may experience mobility difficulties and can easily slip and fall. Further, due to deterioration of memory, the elderly tend to easily forget to take their medicine, or forget the instructions for taking their medicine, having detrimental and sometimes fatal effects.

In addition, most of the aging population is not accustomed to operating electronics or devices to enable frequent communication and interaction with children or other family members living remotely via email or the like. In some situations, the older generation may not be used to using telephonic devices such as the fax machine for communication. Thus, maintaining frequent communication with elder parents that live at a distance remains difficult.

Furthermore, the children of elderly citizens typically have a career and young children of their own to watch over. Even if the aging population had other nearby family members, it would be difficult in practice for the family member to provide adequate care for the aging parent on a regular basis. Additionally, the cost of assisted living for senior citizens is high and the elderly tend to prefer to live independently in their own homes. Thus, there is a need for a mechanism through which family members and the older members of the family can communicate with ease, such that even although there exists a physical distance, the family members can provide the aging family member with love and care.

### SUMMARY OF THE DESCRIPTION

System and method of a networking platform for facilitating interactions and sharing of caretaking responsibilities between family members are described here. Some embodiments of the present disclosure are summarized in this section.

In one aspect, embodiments of the present disclosure include a method, which may be implemented on a system, of managing a set of calendar events of the care receiver, the set of calendar events of the care receiver to be submitted by one or more of the care receiver a caregiver. One embodiment can include, generating a reminder associated with an upcoming occurrence of a calendar event of the set of calendar events at a predetermined amount of time prior to the upcoming occurrence, the reminder to be provided to one or more caregivers. In some embodiments, the reminder is provided via one or more of, an instant message, an email message, a calendar alert, a pop-up screen, a telephone call, an SMS text message, and/or an MMS message. One embodiment further includes updating a status of one or more of the set of calendar events based on an update provided by one or more of the care receiver the caregiver, and/or identifying the schedules of the one or more care givers.

One embodiment further includes identifying at least one responsible caregiver to manage a calendar event of the care receiver by comparing the schedules of the one or more care givers with the set of calendar events. One embodiment includes managing the schedules of the one or more caregivers and/or identifying the schedules of the one or more caregivers via placing a request to the one or more caregivers to provide the schedules. A calendar event of the set of calendar events can, in some embodiments, include, a medical event and/or an appointment with a health care provider.

In one embodiment, the medical event comprises a medication intake reminder. The status of one or more of the set of calendar events includes one or more of, completed, in progress, to be completed by a predetermined time, one or more caregivers who are responsible for supervision, and on hold. In one embodiment, the status of the one or more calendar events includes miscellaneous notes regarding the one or more calendar events, the miscellaneous notes to be submitted by the care receiver and the one or more caregiver.

In one aspect, embodiments of the present disclosure includes a method, which may be implemented on a system, of a family-oriented networking platform. One embodiment includes storing content related to the care receiver submitted by the care receiver, the content to be shared with a set of authorized users of plurality of registered users of the web-based networking platform, receiving a request to access the content by a user of the plurality of registered users, and/or determining if the user is one of the set of authorized users of the plurality of registered users to access the content. The set of authorized users can, in some embodiments, access the content submitted by the care receiver for a pre-determined amount of time.

One embodiment further includes, providing the requested content to the user of the set of authorized users and/or storing content related to the care receiver submitted by one or more of the set of authorized users. In some embodiments, the content related to the care receiver to include one or more calendar events and reminders. Interactions between the set of authorized users are typically facilitated via the networking platform to provide a channel to delegate and manage responsibilities associated with the one or more of the calendar events and reminders for the care receiver. The set of authorized users can be caregivers of the care receiver. In addition, the caregivers are one or more of family members of the care receiver and health care providers of the care receiver. In some embodiments, the content includes at least one of a textual data, image data, animation data, audio data, flash media, and video data and the one or more calendar events comprise a doctor's appointment.

In one embodiment, the reminders comprise a reminder for the doctor's appointment. The one or more of the calendar events and the reminders are, in most instances, submitted by one or more of the caregivers of the care receiver. One embodiment further includes, facilitating interactions via providing message sending and receiving functions in the networking platform and/or providing an interactive calendar accessible via the networking platform by one or more of the caregivers of the care receiver. The embodiment includes, managing the interactive calendar and updating the one or more of the calendar events submitted by the care receiver and the one or more of the caregivers and/or providing a status indicator associated with a calendar event on the interactive calendar. The status indicator can indicate whether a caregiver has assumed responsibility for the calendar event. In some embodiments, the status indicator is update-able in real-time. In addition, the content can include, one or more of, emergency contacts, insurance policies, manuals for medical devices, and prescriptions.

The present disclosure includes methods and systems which perform these methods, including processing systems which perform these methods, and computer readable media which when executed on processing systems cause the systems to perform these methods. Other features of the present disclosure will be apparent from the accompanying drawings and from the detailed description which follows.

### BRIEF DESCRIPTION OF THE DRAWINGS

FIG. 1 illustrates a plurality of caregiver modules to communicate with one another and a care receiver module through a network, according to one embodiment.

FIG. 2 illustrates a schematic of a care receiver module having a processing module, a display module, an imaging module, and a communication module, according to one embodiment.

FIG. 3 illustrates a diagram of a care receiver module having a display coupled with an imaging device, a scanning device, a measurement device, a motion detector, and/or a voice module, according to one embodiment.

FIG. 4 illustrates an embodiment of a schematic diagram of a safety alert system.

FIG. 5 illustrates example screenshots of a user interface of the network platform, according to one embodiment.

FIG. 6 illustrates example screenshots of another user interface of the network platform, according to one embodiment.

FIG. 7 illustrates example screenshots of yet another user interface of the network platform, according to one embodiment.

FIG. 8 illustrates a plurality of devices to communicate with one another and a server via a network, according to one embodiment.

FIG. 9 illustrates a set of databases to store data such as medical records, calendar events, and/or reminders for a service subscriber, according to one embodiment.

FIG. 10 depicts a table illustrating a set of reminders to be presented to a service subscriber, according to one embodiment.

FIG. 11 illustrates a screenshot of a login screen to access a web-based networking platform, according to one embodiment.

FIG. 12 illustrates screenshots of a welcome page for an authorized family member and health care provider of a service subscriber to communicate with the service subscriber, according to one embodiment.

FIG. 13 illustrates a screenshot of a welcome page for a service subscriber to communicate with a family member or health care providers, according to one embodiment.

FIG. 14 depicts a flow chart of a process for facilitating interactions between an elderly and caregivers via an online networking platform, according to one embodiment.

FIG. 15 depicts a flow chart of a process for medical records management, according to one embodiment.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the invention. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure includes systems, methods, and apparatus, for enhancing the likelihood of adoption of a home health monitor system by the elderly through integration of the family networking functions through the home health monitor system. Embodiments of the present disclosure further relate to facilitating web-based interactions between an elderly and caregivers. Embodiments of the present disclosure further include a networking platform for facilitating interactions between family members and a communications channel among family members and health care providers. Embodiments of the present disclosure further include systems and methods for medical records/information management, sharing and/or distribution. Health and well-being can be remotely monitored through facilitating interactions of a care receiver with a care provider, in some embodiments of the present disclosure.

In one aspect, the present disclosure relates to facilitating information and/or data exchange between family members residing in geographically dissimilar areas. In particular, among family members and an aging family member in need of family support and health monitoring.

In an embodiment, the data exchanged include images such as still photography and videos between participating individuals that live far away from one another as a way to stay connected and in tune with each others lives. For example, an aging grandparent can remotely capture a ‘Kodak moment’ of a grandchild which the grandparent would normally not be able to witness due to geographical separation. The information and data exchanged between participating individuals (e.g., service subscribers) may further include past medical records and/or recent diagnosis of another service subscriber such as, an aging family member.

The medical records can be updated by the aging family member, or a family member, who may have recently accompanied the aging parent to a doctor's appointment and is aware of recent diagnosis and prescriptions. In addition to medical records, other information such as, but not limited to, doctor's appointments, instruction for taking medication, and/or other engagements can be exchanged and tracked among one or more participants. Therefore, family members can easily stay atop of the elderly's health, as well as other types of events happening in the aging family member's life.

In another embodiment, health care providers can utilize this facility to update the elderly's medical record and to directly provide diagnosis/suggestions to the elderly and/or the family members. In particular, on items that require attention or follow-up. Health care providers and/or family members alike can monitor the state of health of the aging family member by requesting the aging member to submit vital signs such as pulse rate, respiration rate, body weight, etc.

In one aspect, the present disclosure relates to a motion sensing alert system. The system can include multiple motion sensors installed at multiple locations in an elderly's residence connected to a centralized alarm system. The motion sensors can be installed, for example, at potentially hazardous locations in the home, such as, the bathtub, the staircase, the kitchen, etc. The centralized alarm system can send an alert to a set of individuals (e.g., family members, emergency centers) when one or more of the multiple motion sensors has not detected motion for at least a certain amount of time. The alert can be sent to the set of individuals over a network. For example, an automated call can be placed to one or more phone numbers when motion has not been detected over a predetermined amount of time. In other instances, the alert can be provided to recipients over a wired or wireless network, such as the Internet. The amount of time to be exceeded can be set remotely, for example, by a caregiver, or set by the elderly.

In one aspect, the present disclosure relates to a device to facilitate data uploading, management and distribution among subscribers to the service, such as among family members. In particular, the device includes components, such as an imaging device and/or a scanning device to facilitate uploading and distribution of data such as photography and health-related information within the family members of a family that have subscribed for such a service.

In one embodiment, the device is in the form-factor of a “digital picture frame” that can present data, both graphically and textually to a local user. The local user is in some instances an elderly individual. The “digital picture frame” can include communication functions and is able to receive data from a remote device, which, for example, can be a computing device onto which a photograph can be uploaded by a family member of the elderly. The “digital picture frame” can communicate with several remote devices at once such that the elderly can communicate with many family members residing in dissimilar geographical locations.

In one embodiment, an easy-to-user interface can be presented via the “digital picture frame”. The “digital picture frame” can include physical buttons and/or an on-screen touch pad for the elderly to access the functionalities. In addition to photograph sharing, in one embodiment, the “digital picture frame” includes a messaging function that enables the aging member to send messages to family members, to be delivered in real-time or at a pre-determined time.

In addition, the “digital picture frame” allows the elderly to access functions such as a calendar and an address book. Both of which can be accessed, modified and/or updated by the user (e.g., the elderly), the family members of the elderly, with or without authorization, and/or health care providers with validation of identity and authorization of the family and/or the elderly. In one embodiment, the functions described, including downloading photography, composing/viewing messages, and calendar/address book functions can be accessed with a click of a physical button or on-screen touch key.

In other embodiments, the device can take alternate form-factors without deviating from the spirit of the disclosure. The particular functions described herein include photography, video, messages, emails, and medical information sharing among family members to provide care to and interact with an aging family member.

Other related functions that can be embodied on the device include those that explicitly or implicitly relate to facilitating web-based interactions between an elderly and caregivers. Yet other applications are contemplated beyond use of the disclosure in association with communication between family members, and healthcare providers, such as providing remote health care and monitoring to patients in a clinical setting, hospitals, nursing homes, and the like institutions. Yet further applications are contemplated such as providing childcare and monitoring in a daycare center, kindergarten environment, etc.

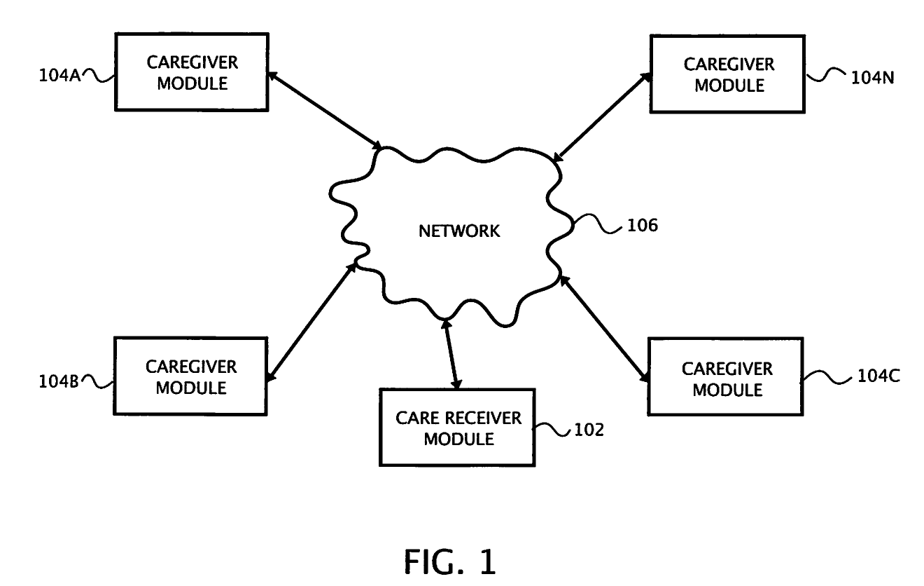

FIG. 1 illustrates a plurality of caregiver modules 104A-N to communicate with one another and a care receiver module 102 through a network 106, according to one embodiment.

Each caregiver module 104A-N and care receiver module 102 can be any system and/or device or in combination of devices/systems that is able to establish a connection with a server or other systems. The caregiver module 104A-N and care receiver module 102 also typically include display functionalities to present data exchanged between the devices to a user. For example, the caregiver module and care receiver module can include but is not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the caregiver module 104A-N and care receiver module 102 are coupled to a network 106. In some embodiments, the modules may be directly connected to one another.

The network 106, over which the caregiver modules and the care receiver module communicate, may be a telephonic network, an open network, such as the Internet, or a private network, such as an intranet and/or the extranet or any suitable combination. In one embodiment, communications to and from the care receiver and caregiver modules can be achieved by one or more secure communications protocols, such as secure sockets layer (SSL), or transport layer security (TLS).

In addition, communications to and from the care receiver and caregiver modules can be achieved via a wireless network, such as, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Wi-Fi, Fixed Wireless Data, or any other wireless data networks.

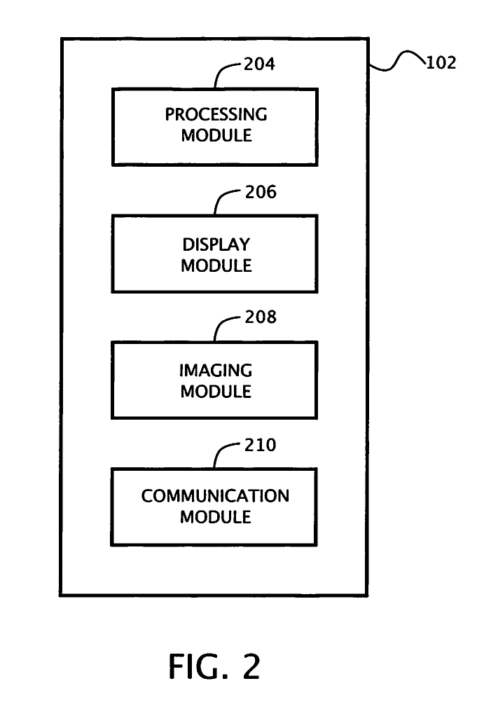

FIG. 2 illustrates a schematic of a care receiver module 102 having a processing module 204, a display module 206, an imaging module 208, and a communication module 210, according to one embodiment.

The processing module 204 of the care receiver module 102, in one embodiment, processes and manages incoming and outgoing requests of data transfer, to and from the care receiver module. For example, the processing module 204 may be responsible for sending a message to a family member (e.g., the elderly grandmother's son Bobby) at a particular time. Similarly, the processing module 204 manages downloads initiated by the user (e.g., the elderly grandmother) and sent by a family member.

The display module 206 can display the interface screen for presenting photographs, messages, emails, a calendar, and/or other reminders to the user. In some embodiments, the display module 206 is an interactive touch screen and displays an on-screen keypad to receive inputs from the user. In some embodiments, the care receiver module 102 may be coupled to external input devices such as a mouse and a keyboard (not shown) to receive user input. The care receiver module 102 may also include an imaging module 108. The imaging module may have photographic capabilities and/or video recording capabilities.

For example, the user may use the imaging module to capture a photograph or a video clip to send to family members through the care receiver module 102. In one embodiment, the imaging module may further include scanning capabilities for document scanning. The scanned document can then be stored on the care receiver module 102 and transmitted to other devices (e.g., caregiver modules) at the request of the user (e.g., the elderly grandmother).

The care receiver module 102 further includes a communication module 210, for interacting with the network 106, through which the care receiver module is able to exchange information/data with caregiver modules. For example, the communication module 210 may be one of, but not limited to, a network card adaptor, a wireless network interface controller (WNIC), a Bluetooth transceiver, a wireless USB hub, a network bridge, a fiber channel host bus adaptor, a telephonic connection, an infrared port, a router device, a network switch, etc.

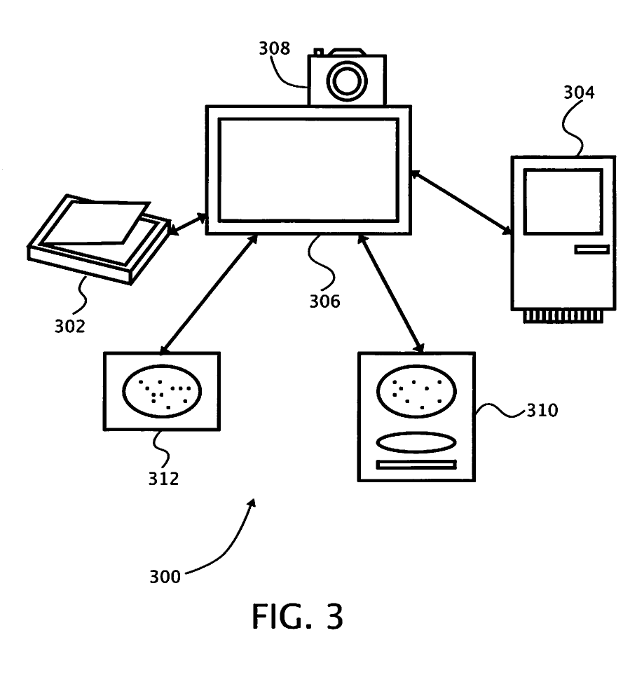

FIG. 3 illustrates a diagram of a care receiver module 300 having a display 306 coupled with an imaging device 308, a scanning device 302, a measurement device 304, a motion detector 310, and/or a voice module 312, according to one embodiment.

In the example of FIG. 3, the care receiver module 300 includes components (e.g., a display, an imaging device, a scanning device, a measurement device, a motion detector, a voice module, etc.) coupled to one another and each component is illustrated as being individual and distinct. However, in some embodiments, some or all of the devices, and/or the functions represented by each of the devices can be combined in any convenient or known manner. Furthermore, the functions represented by the devices can be implemented individually or in any combination thereof, in hardware, software, or a combination of hardware and software.

In the example of FIG. 3, the scanning device 302, can, in some embodiments, enable document scanning, photograph scanning, film scanning, object scanning, text scanning, etc. The scanning device 302 can be any number of modules having any combination of hardware and software components able to analyze images, printed text, handwriting, objects and converts it to a digital image. In some embodiments, images of text can be translated, mechanically or electronically into machine-readable and/or machine-editable text, such as optical character recognition, by any or all of a portion of the modules included in the scanning device 302. The scanning device 302 can be, for example, but is not limited to, one or more of a flatbed scanner, a sheet-fed scanner, a handheld scanner, a drum scanner, a film and slide scanner, a high speed scanner, a rotary scanner, a planetary scanner, 3D scanners and/or a wide format scanner, etc. Various imaging mechanisms can be implemented in any known or other manner, such as, a charge-coupled device (CCD), a Contact Image Sensor (CIS), a photomultiplier tube, without deviating from the spirit of the novel art of this disclosure.

The imaging device 308 as shown in the example of FIG. 3 may in some embodiments perform similar functionalities as the scanning device 302. In particular, the imaging device 308 can include one or more modules having any combination of software and hardware components to facilitate image capture of still and/or moving objects, with or without processing of the image captured. In some instances, a portion of or all of the functionalities of the imaging device 308 can be used for capturing video images. For example, the imaging device, can be, but is not limited to a webcam, a digital single-lens reflex camera, a digital camera (e.g., a compact digital camera, a bridge camera, etc.), a rangefinder camera, a film camera, a movie camera, and/or a video camera. Although one imaging device is shown in the example shown in the figure, the imaging device 308 can be a combination of one or more cameras of the same or differing types, for example, pointed towards different directions to capture images/videos.

Additional functionalities, such as image processing functions, audio recording functions, video/image editing functions, taping/playback functions, live preview functions, may be provided by the imaging device 308 without deviating from the spirit of the novel art of this disclosure. In some embodiments, the functionalities of the scanning device 302 and the imaging device 308 are partially or wholly combined and the functions of which can be implemented in any combination of software and hardware, in part or in whole.

The measurement device 304, in one embodiment, includes one or more functions to obtain vital signs of a user including, but are not limited to, pulse rate, a sphygmomanometer or a pressure sensor to measure blood pressure, respiratory rate, a spirometer to perform pulmonary function tests, a thermometer to determine body temperature, a glucose sensor for identifying glucose level, oxygen saturation level, and intracranial pressure. The measurements could be taken by one device with multiple functions or by multiple devices. The measurement device 304 may be external to the care receiver module 302, as shown. In some embodiments, the measurement device 304 in whole or in part may by internal to or integrated with the care receiver module 300.

The motion detector 310, as shown in the example of FIG. 3, can be one or more modules (e.g., any combination of hardware and software) having a motion sensor to convert detected motion into a detectable signal. For example, motion can be sensed by measuring optical and/or acoustical changes within the range of the motion detector. Infrared light or lasers can be used for optical detection. Motion can also be detected by identifying a change in speed or velocity of an object within a detection range. A motion detector may also be implemented using the imaging device 308 to capture images of an area of interest and identifies motion by performing image processing, for example, on the captured images. Other methods to detect motion are contemplated and do not deviate from the spirit of this disclosure. The motion sensor of the motion detector 310, upon detection of motion, may send a signal to a sound device to generate an alarm. In other embodiments, the signal may trigger other sorts of alarm types, for example, a visual alarm, and/or a vibrational alarm. In some instances, the signal may be sent over a network to other parties that may be interested in motion detection, or the lack of motion.

In the example of FIG. 3, the care receiver module 300 further includes a voice module 312. The voice module can include any number of software and/or hardware components to provide one or more of sound detection functions, audio signal processing functions, speech recognition functions (e.g., automatic speech recognition, computer speech recognition), speech processing functions, voice recognition functions, etc. For example, the voice module 312, may internally include, or be externally coupled to a microphone, such as dynamic microphones, ribbon microphones, condenser microphones, array microphone, or any type of transducer that converts sound into an electrical signal for the purposes of detecting sound. Any number of microphones as suitable depending on the application and/or environment can be used.

The voice module 312 may further include software and/or hardware modules for speech recognition, as implemented by any known or convenient manner, such as, but is not limited to the Hidden Markov model (HMM)-based speech recognition, dynamic time warping (DTW)-based speech recognition. In other embodiments, the electrical signal representing sound may be sent to another module for sound processing, speech recognition and the like functions. In some embodiments, the signals representing sound may be processed on the voice module 312 and sent to another module/device for speech recognition and/or voice recognition (e.g., speaker recognition) purposes. Speech processing includes processing of a digital and/or analog signal, and by way of example but is not limited to, enhancement of speech signals (e.g., noise reduction), speech coding (e.g., signal compression, time compressed speech), voice analysis, speech synthesis, etc. The voice module 312, can include, one or more of, or any portion of the one or more of the above described functions, without deviating from the spirit of the novel art of the disclosure. Of course, the care receiver module 300, can have internally integrated within, any function or any portion of the functions that may be embodied in the voice module 312 as described herein.

The display 306 can be a device with a display screen, such as, but is not limited to, a monitor for a desktop computer, a screen for a laptop computer, a television, a GPS module, a pager display screen, a cell phone display screen, a Smartphone display screen, and/or a display screen of any other portable devices. The display screen may alternatively be a standalone display, such as LCD screen, CRT screen, a projection screen, a plasma display, a Surface-conduction electron-emitter display (SED), an organic light-emitting diode display, and/or other specialty screens, etc.

In some embodiments, the display 306 can be physically and/or functionally (e.g., hardware and/or software components) integrated with one or more of the scanning device 302, the measurement device 304, the imaging device 308, the motion detector 310, and/or the voice module 312. For example, one or more of the above described devices or any physical or functional portion of the one or more of the above-described devices can be integrated with the display rather than externally coupled to the display as illustrated in the example of FIG. 3.

One embodiment of the present disclosure relates to facilitating medical records management storage, tracking, and/or sharing among family members and/or health care providers. The scanning device 302 is utilized by, for example, one or more family members to scan documents, in particular, medical records, diagnosis, medicine prescriptions, to be uploaded to a local storage device, local server, central server for example, such that documents can be downloaded by relevant users, via a web-interface. The documents may or may not require user authorization for download. The documents once uploaded, can be sent to another user, such as another member of the family, a doctor, a nurse, or a pharmacist. Upon an elderly family member's recent visit to the doctor's office, the elderly may wish to upload the records associated with such visit to be stored locally or centrally, for the purposes of records keeping or distribution.

For example, the elderly may wish to provide other family members with updates of their health status, by proactively sending documents to family members or allowing the family members to download the documents. The medical records can also be uploaded for purposes of establishing a means of communication with health care providers and vice versa. For example, if a patient, for whatever reason switches primary care providers, or decides to obtain a second opinion from another doctor, the patient can allow the relevant health care provider to access their health records from their database, rather than having them sent from one clinic to another. In another example, if a patient wishes to have a prescription filled, the prescription can be sent to a pharmacy via the same method. A doctor/pharmacist may also track a patient's collective medication record in such a manner, since different doctors may prescribe different medication, for the purposes of identifying and tracking medications that may not be compatible with one another.

In addition to medical records, medical data, such as data obtainable via the measurement device 304, can be recorded and managed by the care receiver module 300. As discussed, the measurement device 304 may be internal to the care receiver module 300, or external but operationally connected to the care receiver module. In some embodiments, some measurement functions (e.g., blood pressure, body temperature) are integrated into the care receiver module 300, whereas other measurement functions (e.g., pulse rate) are embodied in an external device coupled to the care receiver module 300. Regardless of the externality or internality of the measurement functions, the care receiver module 300 may include software/hardware modules for processing the vital signs obtained by one or more measurement devices 304. Clearly, the care receive module 300 can be coupled to multiple internal and/or external measurement devices. The care receiver module 300 can store the vital signs to be transmitted to family members and/or health care providers. The vital signs may be recorded over a pre-determined period of time prior to being sent to other parties.

In addition to storage and management functions provided by the care receiver module, vital signs can be organized and processed, and in some instances, analyzed by the care receiver module 300. The results of the analysis may be sent to relevant parties such as doctors and other health care providers for review, upon receiving a request, or automatically at pre-determined intervals. Further, the care receiver module 300 may include alert functions to automatically trigger an alert if any of the vitals obtained appears abnormal. The alert can come in one of many forms and the alert can be sent to one of many relevant individuals. For example, the alert can be sent to the doctor's office where a nurse is monitoring one of many such alert signals/messages from multiple care receiver modules, the alert can be an automatic call placed to a medical specialist, depending on the severity and the time of the alert, a call can be placed to 911 and/or an emergency room and/or an ambulance dispatch center.

Other documents, articles, and/or objects that can be scanned, uploaded, and/or transmitted/shared among family members, family members and health care providers, are expected and contemplated. The use of the system as described to facilitate the management, storage, sharing, of such documents, articles, and/or objects, do not deviate from the novel spirit of this disclosure.

A further embodiment of the present disclosure, relates to facilitating communication between family members and providing care for family members, remotely. In particular, to establish a communication channel for family members to care for and to stay in touch with aging family members via a mechanism through which the elderly (e.g., senior citizens, grand parents, parents, etc.) can communicate and interact with their family members who do not necessarily reside within geographic proximity to the elderly. Thus, in addition to the ability of the scanning device 302 to send and upload medical-related documents (e.g., medical documents), the scanning device 302 is for example, additionally used for scanning photographs, birthday cards, notes, drawings to be sent to one or more family members.

For example, grandma may send out a message to be mass distributed to all family members indicating that Thanksgiving gathering will be taking place at grandma's home at 6:00 PM sharp. Similarly, grandchildren can send grandma a birthday card via uploading the document with the scanning device 302 and sending the birthday card to the grandma, or uploading the card specified for the grandma to download. The grandchild can, for example, send grandma a message indicating that a card for grandma has been uploaded, and is ready for grandma to download.

In one embodiment, communication between family members, and/or between family members and health care providers, and/or between health care providers of an elderly/patient is enabled and facilitated. In some embodiments, based on the identity of a service subscriber, different communication channels and/or methods of communication are made available to the subscribers. The elderly grandma can send messages, as described by scanning a hand written or typed note/card and transmitted electronically to family members. In some embodiments, the elderly can type a message (e.g., instant messaging, email, SMS, MMS, IRC, etc.) via a peripheral device with input capabilities (e.g., mouse, keyboard, etc.) that is coupled to the care receiver module 300. The message can be sent to a select group of one or more recipients including family members and/or health care providers.

Furthermore, the imaging device 308 can be utilized by the elderly to take photographs to share with family members. In some embodiments, once pictures are taken by the imaging device, the pictures may be automatically uploaded to a local and/or central server. The elderly can be given the option to upload to a central server, or to transmit the data in an email and/or a message as an attachment to the relevant family members.

Communication channels provided to participants may depend on the identity of the participants. For example, real-time communication channels may be available for family members, whereas communications with health care providers can be limited to non real-time communication channels, such as email. Certainly, rules of exceptions can be contemplated, such as in times of emergency, a real-time communications link can be established between an elderly and a health care provider, and vice versa.

One embodiment of the present disclosure relates to an alert system, in particular, for detecting an emergency or hazardous situation and acknowledging one or more relevant parties. The motion detector 310 can be utilized to determine if a period of time over which motion has not been detected has exceeded a pre-determined threshold. For example, an elderly who trips and thus falls may have difficulty moving or getting up to call for help. Thus, the motion detector 310 may be setup to place a call to a family member, perhaps living close by, or the neighbor next door. The pre-determined threshold is adjustable and can be application, and individually dependent.

The appropriate course of action can be based on the detection of different types of movement, or the lack of detection of motion. For example, motion can be monitored and analyzed over a pre-determined amount of time, to determine the proper course of action. In one embodiment, if drastic motion is detected followed by a motionless period, a call and/or an alert is generated and placed to a medical crisis unit, an ambulance dispatch center, a critical care facility, a police station, 911, etc.

If a drastic motion is detected, followed by slower motion, a call can be placed to a family member indicating that the elderly may have fell and appears to be alright, but a check-up may be in order. The alerts can be sent to any device able to receive a signal, with wired and/or wireless connectivity (for example, but is not limited to, a telephonic signal, an electrical signal, an optical signal, an electrochemical signal, an electromagnetic signal, etc.), such as a computer, a laptop, a cell phone, a Smartphone, a BlackBerry, a Treo, an iPhone, a telephone, a pager, a television, etc.

In one embodiment, multiple motion detectors (such as the motion detectors 310) are installed at various locations in the home of the elderly. Locations potentially hazardous (e.g., the staircase, kitchen, bathtub) can be monitored with additional motion detectors since trauma, slipping, and/or falling are likely to occur. The multiple motion detectors may be wired and/or wirelessly coupled to the care receiver module 300 to provide motion information, for example, for processing and analysis.

In some embodiments, other types of detectors, monitoring systems (e.g., disease monitors), sensors, are coupled to (wired or wirelessly) or otherwise integrated with the care receive module 300. For example, one or more smoke detectors can be coupled to the care receiver module 300, and an alert can be sent automatically to a local fire department if a smoke detector goes off. Other types of sensors and/or detectors may be directly linked to specific doctor's offices. For example, a pacemaker can trigger an alert to be sent to the cardiologist's office under a pre-determined set of circumstances that indicate a need for attention or follow-up.

In one embodiment, one or more features carried out by the modules described about can in whole or in part be activated by voice, through sound detection by, for example, by the voice module 312. In particular, a document may be scanned when a recognized command is vocalized, photography may be taken when a recognized command is vocalized and detected. Further, voice detection can be utilized to place calls, to send messages (e.g., a voice message can be automatically converted to text and sent), to initiate a measurement to take vital signs, to download a file, to access an uploaded document, to send a message to grandson Bob, etc. Such a function provides a convenient way, especially for elderly individuals to operate electronics, in particular, for those with mobility difficulties or those with difficulty learning operating electronics. Some or all of the functions represented by modules in the example of FIG. 3 may be voice commanded.

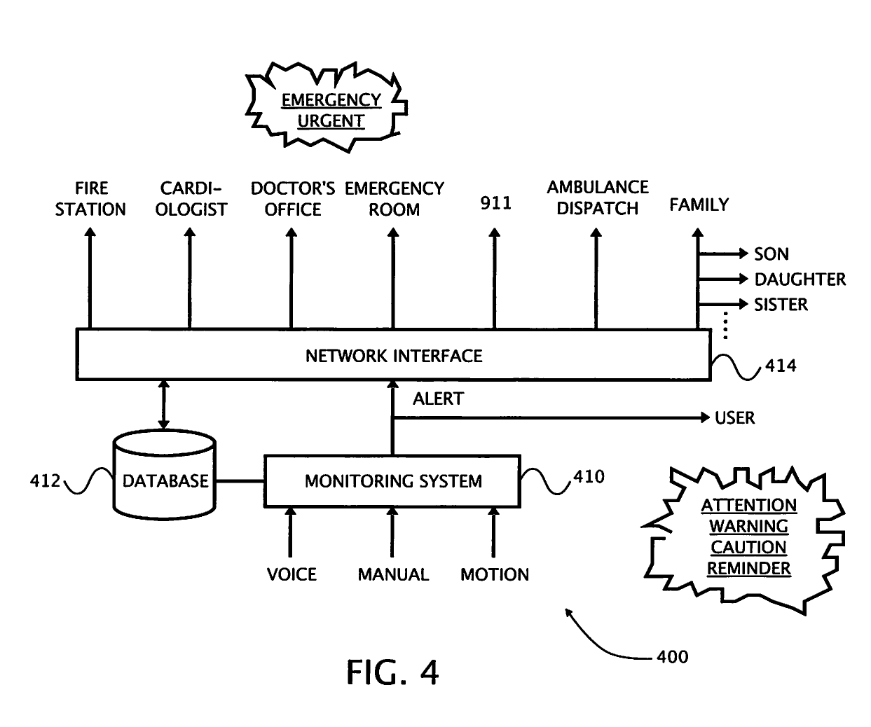

FIG. 4 illustrates an embodiment of a schematic diagram for a safety alert system 400.

In the example of FIG. 4, the safety alert system 400 includes a monitoring system 410, a database 412, and/or a network interface 414. The monitoring system 410 includes any number and combination of sensors, detectors, and additional systems, implemented with any combination of hardware and/or software modules. For example, the monitoring system 410 may include one or more of, a motion detector, a disease monitoring system, a medical monitor, a pulse oximeter, a heart beat monitoring device, a smoke detector, a burglar alarm, position sensor, pressure sensor, and/or any other sensing devices/detectors, etc. In addition, the monitoring system may further include a presence sensor and/or a heat sensor. The presence sensor may serve similar purposes as the motion detector, to detect the presence or the lack of presence of an individual. The heat sensor can also be used to detect the presence or the lack of presence of an individual based on body temperature.

The monitoring system 410, although illustrated as being one collective element, could be comprised of distributed components (physically distributed and/or functionally distributed) including various detectors, sensors, and/or detectors coupled to one another and/or to a central server or processor to store and/or analyze the data received from the distributed elements, collectively or in a distributed fashion.

The monitoring system 410 represents any one or a portion of the above discussed functions. In some embodiments, the monitoring system 410 does not include the physical components that perform the monitoring/measurements but rather a central storage to stored one or more sets of data to be provided to a particular recipient upon request. The monitoring system 410, in one embodiment, organizes data received from the one or more measurements to be provided to a recipient, the recipient can be one or more of an entity, institution or individual. In some embodiments, the monitoring system 410 may include data processing and/or analyses functions, such as, but are not limited to, computing statistical attributes of the data received from the measurement/monitor devices, curve fitting, data mining, selecting or discarding certain subsets of a set of data based on specific criteria, etc.

In one embodiment, the monitoring system 410 includes multiple motion detectors installed at an elderly's residence. The motion detectors can be installed at different locations throughout the residence. Further, additional motion detectors can be installed potentially hazardous locations such as the bathtub, staircase, kitchen, etc. In one embodiment, the motion detectors are coupled to a central unit (e.g., a first unit). The central unit can receive an alarm signal from the one or more of the plurality of motion detectors when motion has not been detected for a predetermined amount of time from at least one of the plurality of motion detectors. In addition, the central unit can generate the alarm signal when motion has not been detected by the motion detectors for at least the predetermined amount of time.

In one embodiment, an alarm signal is generated upon detection of motion. For example, an Alzheimer's patient or a patient that is otherwise mentally ill may be advised to minimize movement beyond a certain location. Therefore, any motion that is detected outside the designated location may trigger an alarm. Similarly, the detector settings may be adjustable when the patient has a visitor such that the alarm does not go off when motion of the visitor (e.g., family, doctors, etc.) is detected.

The predetermined amount of time to be elapsed before an alarm is generated can be set locally, for example, manually by the elderly at the elderly's residence, or remotely, for example, by family members. In some embodiments, motion detector/sensor are individually configurable as to when to trigger an alarm, based on whether detection of motion or the lack of detection of motion, and the time of day during which different settings are applicable. In addition, the amount of time to be elapsed can be automatically synchronized with the elderly's electronic calendar. For example, if the elderly is scheduled to be at a lunch meeting between noon and 2PM, the motion detectors are not expected to detect motion during that time. Therefore, the alarm may be configured to go off when the motion is detected when motion is not expected.

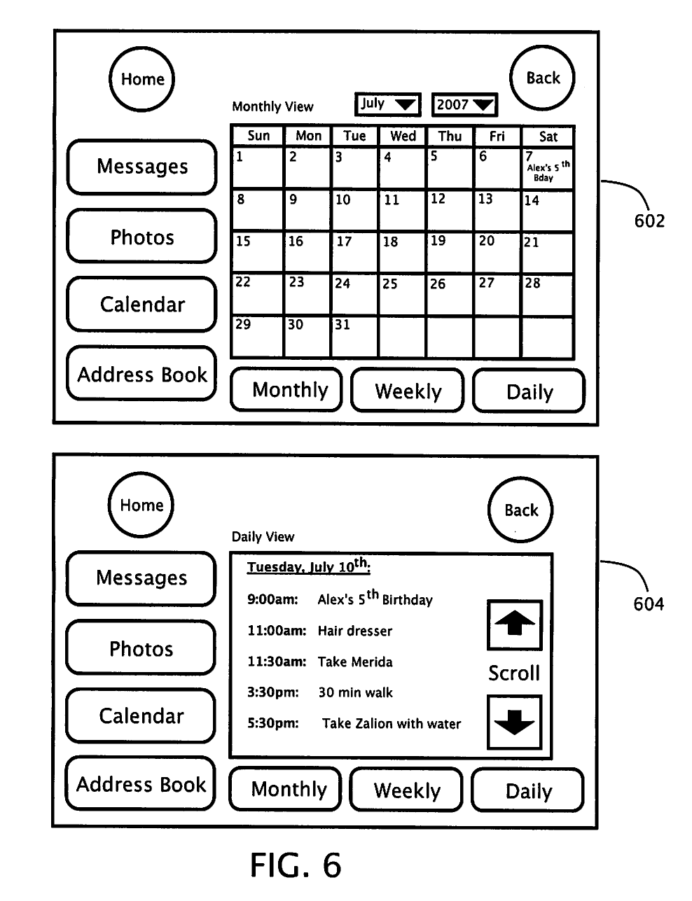

For example, if the elderly typically cooks and eats dinner between 6 PM-7:30 PM, the motion detector in the kitchen is expected to detect frequent motion during this time period. In one embodiment, settings for elapsed time before an alert is to be triggered on the motion detectors can be automatically coupled to the elderly's calendar events (e.g., the calendar of FIG. 6). For example the motion detectors can be wired and/or wirelessly synced to a server hosting the calendar. In some embodiments, the motion detectors in a residence can have a different setting related to the elapsed time to alert. The elapsed time to alert is, for example, a function of both the location of the motion detector and the time of day.

In one embodiment, a plurality of receiver units is communicatively coupled to the central unit over a telephonic network connection. The plurality of receiver units can receive the alarm signal sent from the central unit indicating that motion has not been detected for at least the predetermined amount of time from one or more motion detectors in the residence of the elderly. In addition, the plurality of receiver units can receive the alarm signal sent from the central unit indicating that motion has been detected when motion is not to be expected.

The receiver unit can be any device able to receive a wired and/or wireless signal. For example, the receiver unit can be a telephonic device (e.g., telephone, cellular phone, PDA, Blackberry, pager, etc.). When an alert is generated, a phone call can automatically be placed to a designated set of recipients (e.g., identified by unique phone numbers) such as family members and/or health care providers.

In some embodiments, the monitoring system 410 compares one or more sets of data based on measurements obtained from sensors/detectors that may be internal or external to the monitoring system 410, against a set of pre-determined criteria. The pre-determined set of criteria can be identified by performing a lookup in the database 412. The database 412 can be internal or external to the monitoring system 410. The set of pre-determined criteria provides a guideline for which to determine if a particular set of data or a combination of sets of data requires medical attention. For example, if a pulse rate exceeds a threshold (e.g., 145 pulses/minute) a call to the doctor can be suggested. The predetermined criteria may further be specified for an average value over a pre-determined amount of time. Similarly, the pre-determined criteria can be specified in terms of the standard deviations over the pre-determined amount of time, for some measurements, for example.

The pre-determined criteria may include tiered specifications. For example, if the detected pulse rate is <55 pulses/min on average for more than 3 minutes, the emergency room is to be contacted immediately. If the pulse rate is averaged between 55-110 pulses/minute, no alert is to be triggered. If the pulse rate is averaged >110 pulses/minute for over 5 minutes, the doctor's clinic or a family member may be contacted, for example. Pre-determined criterion can be specified in terms of time averages, deviation from the expected/normal value, etc. Alerts indicating varying degrees of severity can be generated and sent to differing parties.

For example, in the event that an urgent health matter occurs, the 911, emergency room, ambulance dispatch may be notified directly. In the event that attention is needed, for example, if the elderly is low on medication, the doctor's office and/or a family member can be notified. In some situations, an alert can be sent to the elderly as reminder to take medication or vitamins. For example, if the detected glucose level in the system of a diabetic patient is below a pre-determined threshold level, an alert may be triggered as a reminder for an insulin shot. If the detected glucose level, for example, further rises above a next threshold level, a health care provider may be contacted.

As shown in the example of FIG. 4, an alert can be relayed over a network 414 to one or more of many entities, for example, but is not limited to family members, the elderly, the fire station, a specialty clinic (e.g., the cardiologist), the primary physician's office, the emergency room, 911, ambulance dispatch, police station, a critical care facility, intensive care, etc. Since information regarding health is in some instances transmitted over secure or insecure network, encryption algorithms are implemented in some embodiments, such that medical records and/or related information cannot be intercepted for ensuring patient privacy and to further comply with HIPAA (Health Insurance Portability and Accountability Act) standards, which establishes regulations for the use and disclosure of Protected Health Information (PHI). PHI includes any information about health status, records, medical data, provision of health care, or payment of health care that can be linked to an individual. The encryption can be implemented by any convenient and/or known algorithm, such as, but is not limited to, DES, Triple DES, RSA, Blowfish, Advanced Encryption Standard (AES), CAST-128, CAST-256, Decorrelated Fast Cipher (DFC), Tiny Encryption Algorithm (TEA), eXtended TEA (XTEA), Corrected Block TEA (XXTEA), and/or RC5, etc.

The network 414, over which the alert can be transmitted and received, may be a telephonic network, an open network, such as the Internet, or a private network, such as an intranet and/or the extranet or a combination. In one embodiment, communications can be achieved by a secure communications protocol, such as secure sockets layer (SSL), or transport layer security (TLS). In addition, communications can be achieved via a wireless network, such as, one or more of a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

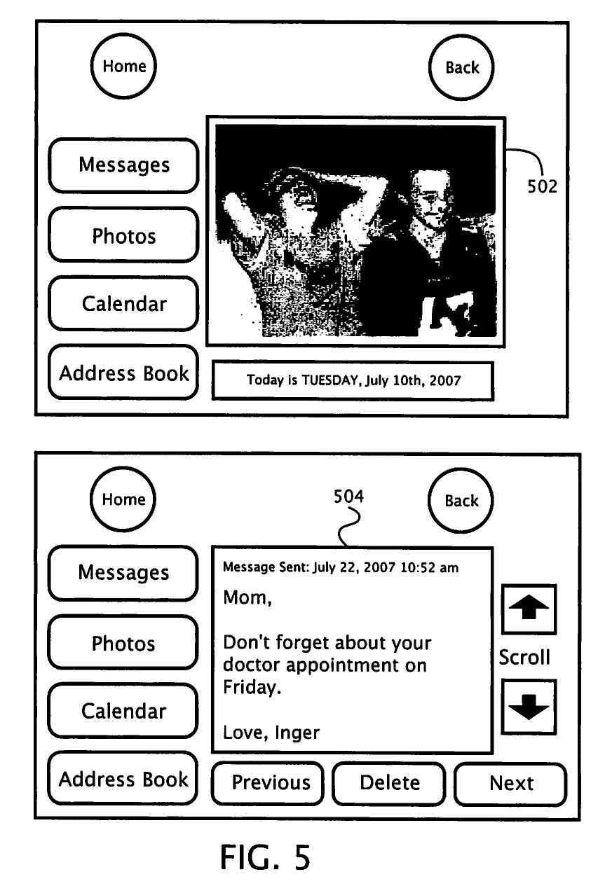

FIG. 5 illustrates example screenshots of the care receiver module screen, according to one embodiment.

In the example of FIG. 5, a photograph of family members is displayed on the main frame of the screen in the screenshot 502. In some embodiments, one or more photographs are displayed simultaneously on the screen like a slideshow. One or more photographs can also be displayed sequentially on the screen. The photographs can be displayed automatically when it is received. In other embodiments, the ‘Photos’ icon may be highlighted son the screen, in any known or convenient manner, to indicate to a user that there are new photos to be viewed.

After a photo has been viewed, in one embodiment, the user may use the photo as background, close the photo and store it locally, and/or store the photo on a centralized server. The photos can be stored to be accessed later and/or to be shared with other users or family members. In some embodiments, after viewing a picture, the user may forward the document as an attachment to other users/family members, using the ‘Photos’ icon. By using the ‘Back’ button, the user may browse through a set of photographs attached with a message, a set of photographs stored locally, and/or a set of photographs stored remotely, on a centralized server. In one embodiment, the ‘Home’ button is used to return to the desktop screen.

In another example of FIG. 5, a message/email from a daughter of the user is displayed on the main frame of the screen as illustrated in the screenshot 504. In some embodiments, more than one message can be displayed on the screen simultaneously, depending for example, on the size of the display screen. The message can be displayed automatically when it is received. In one embodiment, the ‘Messages’ icon may be highlighted, in any known or convenient manner, to indicate that a new message (e.g., instant message, email, text message, SMS, MMS, etc.) has been received. The new message may be displayed on the screen when the ‘Messages’ button has been hit. When a message has been read, the user can choose to read the previous message, delete the previous message, or read the next message.

In some embodiments, after the message has been read, the user can further choose to save the message locally, to forward the message to another user, and/or to store the message on a centralized server for others (e.g., family, health care providers) to access. In addition to receiving messages from family members, messages from health care providers (e.g., doctors, pharmacists, and/or nurses) can be received as well. The message contents can include but is not limited to, invitations, reminders for doctors' appointments, reminders for events, email messages, and/or medication refill reminders, etc. The message may be stored, forwarded, sent, using one or more buttons displayed on the screen, such as the ‘Messages’ button, in conjunction with any input devices.

FIG. 6 illustrates example screenshots of the care receiver module screen, according to one embodiment.

In the example of FIG. 6, a monthly view of a calendar is displayed on the main frame of the screen in the screenshot 602. Weekly view and daily views of a calendar can be displayed through clicking on the icons ‘Monthly’, ‘Weekly’, ‘Daily’ near the bottom of the screen shown in the screenshot. The different views of the calendar can be populated with events occurring on a particular day and/or at a particular time. For example, Alex's 5th birthday is shown on the calendar to occur on Saturday the 7th. The calendar view can be initiated utilizing the ‘Calendar’ button, which is, in one embodiment, on the left hand side of the screen. In another example of FIG. 6, a daily agenda is displayed on the main frame of the screen in the screenshot 604. As shown, the agenda includes a number of entries, including, a birthday event (“Alex's 5th Birthday), a salon appointment (“Hair dresser”), a medication reminder (“Take Merida”), an exercise reminder (“30 min walk”), and another medication reminder (“Take Zalion with water”). Other types of reminders and event entries can be included on the calendar.

The user calendar can be populated by individuals other than the user. For example, if a family member of the user is throwing a birthday party, the family member can add an entry on the user's (or the elderly's) calendar as a reminder. In one embodiment, health care providers of the elderly can submit calendar entries. For example, the clinic personnel can enter doctor's appointments into the calendar at the time the appointment is made. The calendar can be accessed remotely, in one embodiment, via the Internet. Similarly, medication refill entries can be entered into calendar by the pharmacy.

In one embodiment, if a doctor's appointment is to be cancelled and rescheduled, the doctor's office can automatically update the user's calendar and send the user a message acknowledging the user of the change. In some instances, if the proposed appointment date does not work, the user can propose another time and date utilizing the same calendar. Note that calendar entry submission by various users typically conform to privacy and access rules. For example, a valid identification authentication may be necessary to submit an entry to another user's calendar. Although some users have access to other user's calendar, a write access may or may not be granted.

In some embodiments, one or more calendar entries can be shared with other users. For example, family members of an elderly individual may have access to the calendar. In one embodiment, each family member has his or her own logon information. The user may choose to share certain calendar entries with certain family members and/or health care providers, or to keep them private. Since the identity of each user can be identified by the information submitted during logon, privacy and access rights of the user can therefore be enforced.

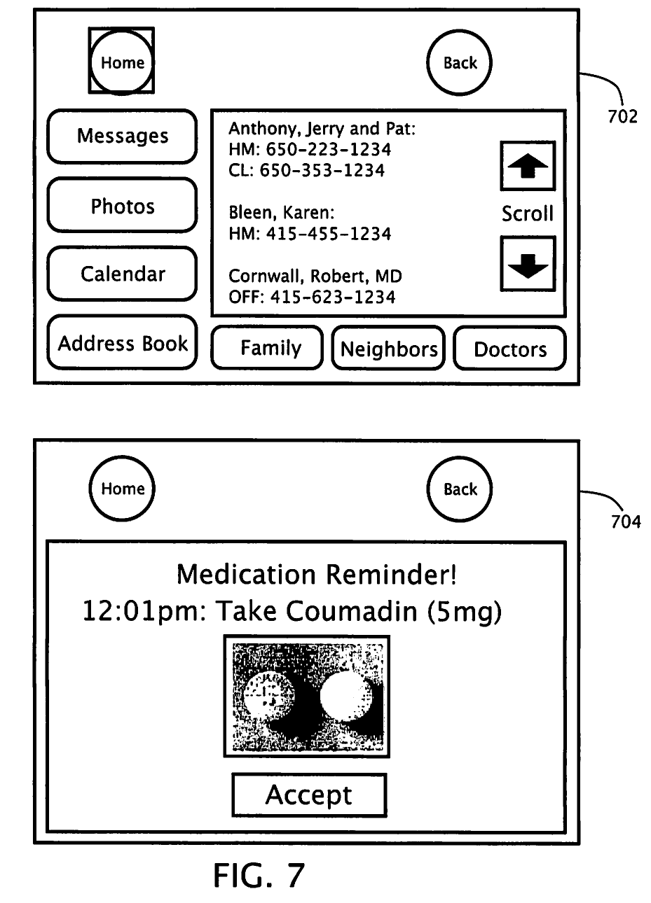

Some calendar entries, for example, entries for doctor's appointments may not be kept private, to ensure that family members can keep track of the elderly individual's health and to remind them of their doctor's appointments. Some calendar entries, for example, doctors' appointments, not only trigger a reminder or alarm to remind the elderly individual, but also trigger an alarm on the caregiver's end. The alarm may be triggered on any device able to receive a signal and generate an alarm (e.g., visual, audible, vibrational, etc.). In the example of FIG. 7, a reminder for taking medication is displayed on the screen in the screenshot 704.

FIG. 7 illustrates example screenshots of the care receiver module screen, according to one embodiment.

In the example of FIG. 7, a few entries of an address book is displayed on the main frame of the screen in the screenshot 702. The address book can be accessed by the button “Address Book”, and organized into a number of categories, “Family”, “Neighbors”, and “Doctors”. By clicking the icons, in one embodiment, the screen can be populated with the contact information of the contacts on the contact list within the category selected. Similar to calendar entries, address book entries can, in some instances, be entered and accessed by caregivers (e.g., family members and/or health care providers) of the elderly. Similar to calendar entries, privacy and access rules may apply to different users/caregivers.

The screenshots shown in the examples of FIGS. 5-7 can be displayed on a care receiver module (e.g., care receiver module 102, 202, 302, etc.). In addition, the screenshots can further be displayed on any device with a display screen, such as, but is not limited to, a monitor for a desktop computer, a monitor for a laptop computer, a television, a GPS module, a cell phone display screen, a Smartphone display screen, and/or a display screen of any other portable devices. The screenshots may be displayed as shown in the examples of FIGS. 5-7 or the layout may be adjusted, for example, based on the attributes of the display screen, without deviating from the spirit of the disclosure. Additional settings on the display may or may not be required for displaying the screenshots, as shown in the FIGS. 5-7. Attributes of the display screen include, by way of example but is not limited to, screen resolution, aspect ratio, size of the display, color depth, dot pitch, and/or refresh rate, LCD screen, CRT screen, and/or plasma display, etc.

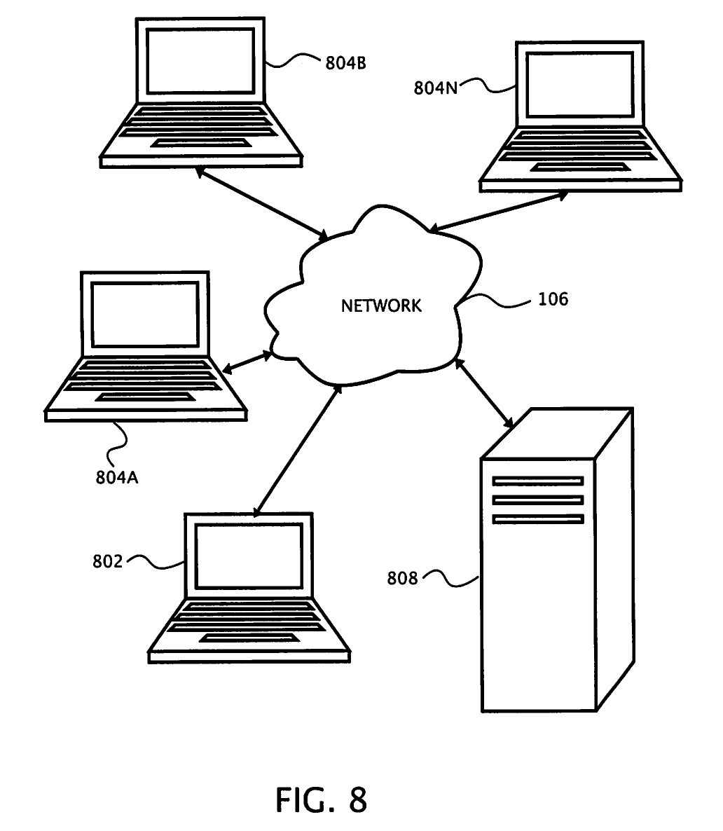

FIG. 8 illustrates a plurality of devices 802, 804A-N to communicate with one another and a server device 808 via a network 106, according to one embodiment.

In the example of FIG. 8, the plurality of devices 802, 804A-N can be any type of system or device able communicate with a database, a server and/or another device. The devices 802, 804A-N also typically include display functionalities to present data exchanged between the devices to a user. For example, the devices can include but is not limited to, a server desktop, a desktop computer, a computer cluster, a mobile computing device such as a notebook, a laptop computer, a handheld computer, a mobile phone, a smart phone, a PDA, a Blackberry device, a Treo, and/or an iPhone, etc. In one embodiment, the device 802 is a client end module suitable for a care receiver and can include the functions as described in the care receiver module 300 in the example of FIG. 3.

In one embodiment, the devices 802, 804A-N and server 808 can be coupled to a network 106. The server 808 can be any combination of hardware and application program for accepting incoming requests and generating a response to the incoming requests. The server can be executed on a same computer as a client application, or the client application and the server can communicate through a network. The server 808 can be one or more of, or a combination of one or more of the following, but is not limited to, a file server, a database server, a backup server, a print server, a mail server, a web server, an FTP server, an application server, a VPN server a DHCP server, a DNS server, a WINS server, a logon server, a security server, a domain controller, and/or a proxy server, etc.

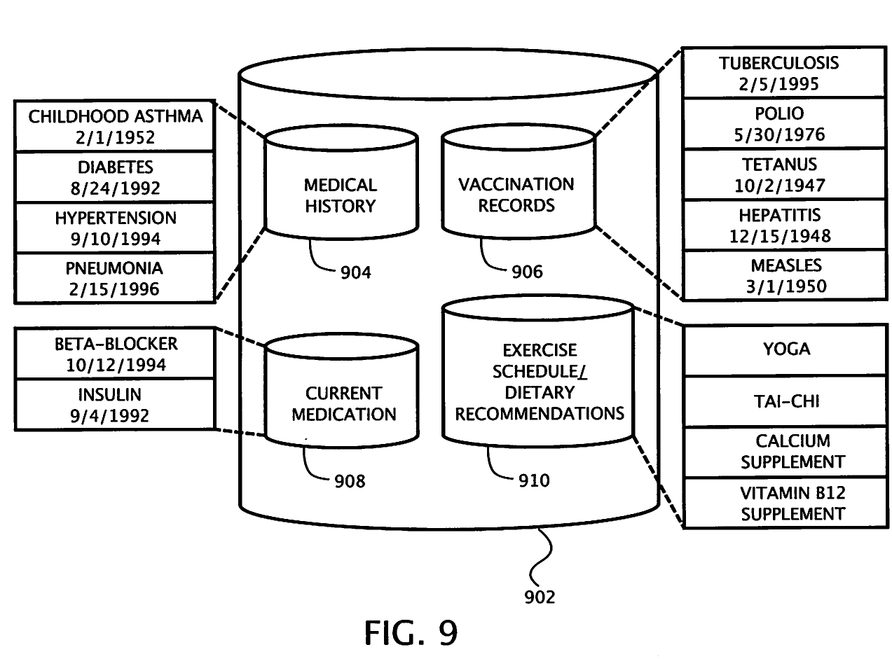

In addition, the server 808 can be externally coupled to or internally integrated with a database (not shown) accessible by the devices 802, 804A-N. In the example of FIG. 9, described in more detail below, a set of databases couple-able to the devices 802, 804A-N are to store data such as medical records, calendar events, and/or reminders for a service subscriber, according to one embodiment. Other types of data and information can be stored, one or more of the set of databases. In some embodiments, the server 808 need not be present for the devices 802, 804A-N to access the database.

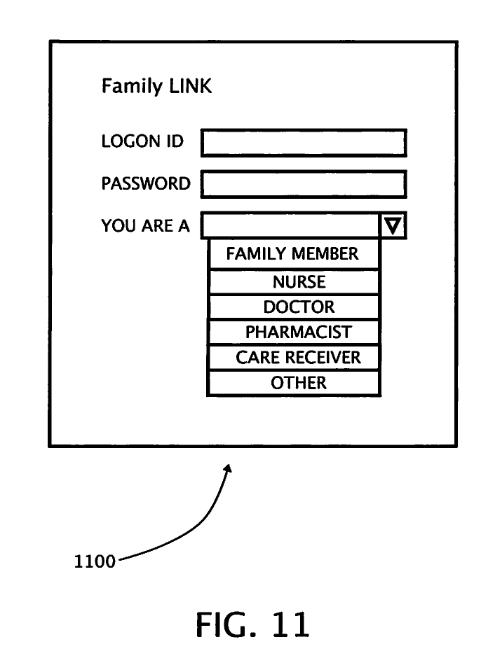

In one embodiment, the device 802 is a client end module for a care receiver and can be any known or convenient consumer electronic device or include the functions of the care receiver module 300 as described in FIG. 3. Similarly, the devices 804A-N can be client end modules for one or more caregivers and can be any known or convenient consumer electronic device or include additional suitable functions that are contemplated in the applications of facilitating interaction with elderly individuals to provide care and to monitor well-being. Interactions between an elderly and health care providers can be facilitated by any number of devices (e.g., devices 802, 804A-N) coupled through the network 106. In one embodiment, the interactions can be facilitated through a web-based networking platform, including functions similar to but is not limited to, those shown in the screenshots of FIGS. 5-7 and screenshots of FIGS. 11-13.

For example, through the network 106, communications between caregivers and care receivers can be channeled to the relevant parties; the communication include, but is not limited to, phone calls, VoIP, instant messaging, text message, emails, document sharing, document uploading, records updating processes, etc. In some embodiments, documents provided by the caregivers and/or the care receivers can be stored and/or managed on the server 808 or a central database. Centrally stored documents may be accessed and/or downloaded by a care receiver and/or a caregiver, when the requesting individual is authorized to access the document requested (e.g., medical information and records). Some documents may be stored and/or managed locally at devices 802 and 804A-N, for example, and sent to the relevant parties when appropriate.

Further, documents and attachments such as photography, videos, notes, cards, etc. can be uploaded to the centralized database for download by the intended recipient (e.g., an elderly individual, a family member of the elderly) or sent to the intended recipient over the network, through the web-based networking platform. The communications and interactions described above can be facilitated through a networking platform service. For example, a registered caregiver and/or care receiver can submit logon credentials to enter, for example, a customizable space on the web. When logged in, the registrant can access and upload documents, photography, videos to be shared with other registrants, who are, in most instances, family members, health care providers, and/or other caregivers. Alerts and notifications can also be provided when a registrant logs on to the service.

Other information to be shared include health related information, recorded at a clinic or at home, medical bills, health insurance information, medication records, diet regime, exercise regime, and/or any other information, data, services, related to monitoring the well-being of a patient/elderly. Other services, functions, and features of the networking platform related to providing care to the patient/elderly, to generally increase the quality of life for the patient/elderly, providing a channel through which caregivers (e.g., family, health care providers) can collectively and in a distributed fashion, connecting and interacting with one or more elderly individuals, to share the responsibility of caring for an elderly family member, are contemplated and expected, and do not deviate from the novel techniques described herein. In particular, the services, functions, and features, described herein can be suitable for the elderly and caregivers that are not necessarily geographically proximal to one another. Some example screenshots of the network platform service are illustrated in FIGS. 11-13.

FIG. 9 illustrates a set of databases on the server to store data such as medical records, calendar events, and/or reminders of a service subscriber, according to one embodiment.

The set of databases 902 can include one or more separate databases as illustrated. For example, the database in the example of FIG. 9 stores different types of information, including medical history in database 804, vaccination records in 806, and current medication in database 808, and/or exercise schedule/dietary recommendations in database 810. More or less databases may be included. The databases can store other types of information, including but is not limited to, additional health related information, obtained at a clinic or at home, medical bills, health insurance information, medication records, and/or any other information, data, services, pertaining to monitoring the well-being of a patient/elderly.

Additional data that can be stored in databases, can be, but is not limited to, related to delivering the services, functions, and features of a web-based platform to facilitate and/or to provide care to the patient/elderly, to generally increase the quality of life for the patient/elderly, to provide a channel through which caregivers (e.g., family, health care providers) can collectively and in a distributed fashion, connect to and interact with one or more elderly individuals, to share the responsibility of caring for an elderly family member, are contemplated and expected, and do not deviate from the novel art of this disclosure. In some embodiments, one or more databases can be implemented as one database and different types of information can be stored in combination rather than in separation as shown in the example of FIG. 9.

In one embodiment, the medical history database 804 stores information related to the historical record of a person's health, for example dating as far back as data is able to be obtained. Medical problems, diseases, treatments that occurred in the past can be included, for example, childhood asthma, diabetes, hypertension, pneumonia, etc. In some embodiments, dates of diagnosis, treatment, and prescribed medication associated with a disease or symptom can be stored as well. Medication records including medications prescribed in the past may also be recorded and tracked, to screen for potential incompatibilities, etc. In addition, vaccination records such as tuberculosis, polio, tetanus, hepatitis, measles shots for example can be recorded, including the locations and/or dates when the shots were administered.

Oftentimes, vaccinations require re-administrations after a few years to provide immunization, in some embodiments this may be recorded in the databases as well. The medication that a patient is currently taking can also be stored, for example, beta blockers, and insulin. In one embodiment, the date the medication was prescribed, dosage information, instructions are stored in the database. Further, the database may include a schedule of an exercise regime and/or dietary recommendations. The exercise and diet regimes can be submitted by nutritionists, physical therapists, or by the elderly/patient.

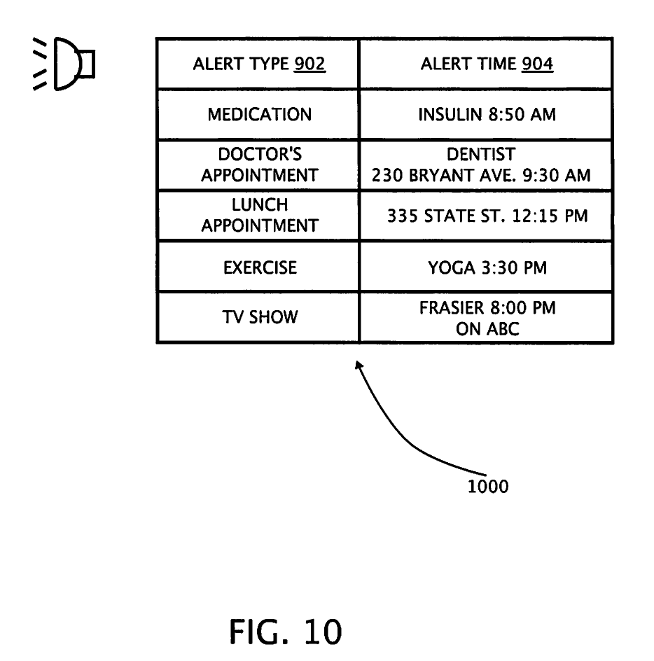

FIG. 10 depicts a table 1000 illustrating a set of reminders to be presented to a service subscriber, according to one embodiment.

In the example of a table depicted in FIG. 10, various types of alert events 1002 can be entered, automatically or manually. For example, an appointment or an event 1002 entered into a calendar can automatically be associated with an alert in the system. The event for which an alert is to be generated for, can further include detailed information (e.g., type of exercise, type of restaurant, time/place of appointment, etc.) about the event 1004. Various alerts can be generated, including, but are not limited to, scheduled intake of medication (e.g., insulin at 8:50 AM), a doctor's appointment (e.g., a dentist appointment at 230 Bryant Ave. at 9:30), a lunch meeting (e.g., at 335 State St. at 12:15 PM), to attend an exercise session (e.g., Yoga at 3:30 PM), to view and/or record a TV show (e.g., Frasier at 8:00 PM on ABC), etc.

In some embodiments, the registrant can sign-up to receive notifications even when the registrant is not logged on to the service. For example, reminders for doctors visits, emergency events that are detected, submitted to the service, or otherwise identified by the service can be provided through other communication channels, by way of example but not limited to, through an email message, in an SMS text message, in a phone call, triggering an alarm, etc. The type of communication through which an alert is to be provided can be manually configured or automatic, and stored in the database as well.

FIG. 11 illustrates a screenshot 1100 of a login screen to access a web-based networking platform, according to one embodiment.

In the example of FIG. 11, the platform utilizes a password identification method for authorizing access. In other embodiments, other forms of identity authentication, include but is not limited to, security cards, digital certificates, biometric identifiers (e.g., fingerprints, retinal scans, facial scans, DNA, etc.) can be utilized and are contemplated and in accordance with this disclosure. In the example of FIG. 11, the logon screen provides a drop-down box for the user to indicate whether the user is a family member, a nurse, a doctor, a pharmacist, or a care receiver. In one embodiment, this information can be automatically associated with a user's logon information. A user may be able to obtain a logon ID after subscribing or registering. The user may be able to obtain a trial account. In addition, the user may be invited by a registered user, such as a care receiver, such that the user may be given a guest account, with limited features compared to a full account. A subscription fee may be charged to service subscribers on a one-time basis, a monthly basis, a yearly basis, usage based, or based on other fee structures.

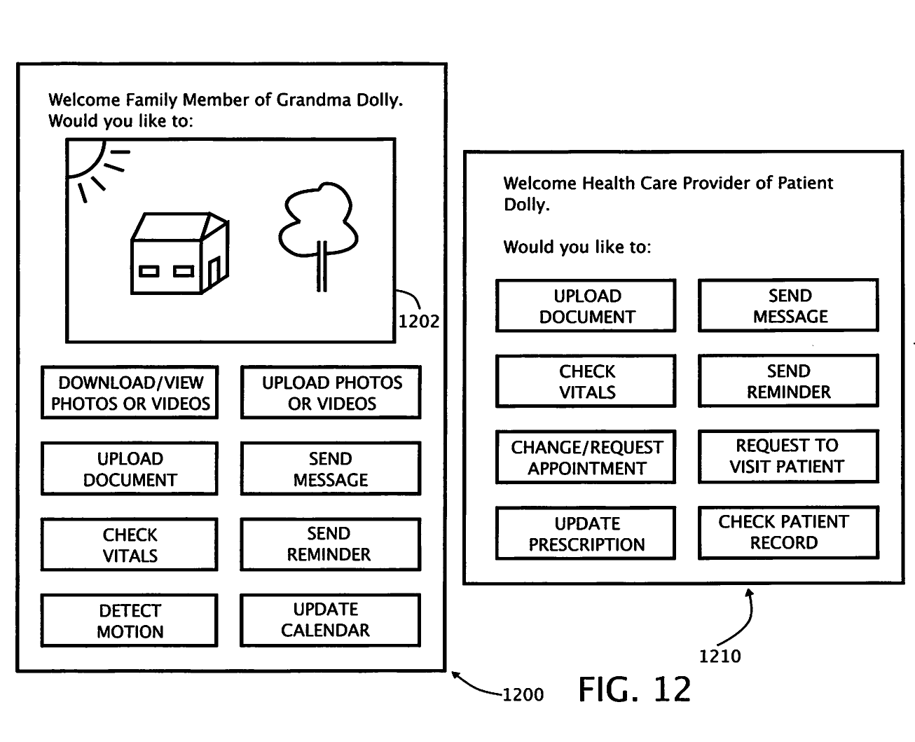

FIG. 12 illustrates screenshots 1200 of a welcome page for an authorized family member and health care provider 1210 of a service subscriber to communicate with the service subscriber, according to one embodiment.

A welcome screen for a family member of a care receiver (“Grandma Dolly”) is illustrated in the example screenshot 1200 of FIG. 12. The welcome screen in the example includes a main frame 1202 for which information and images can be displayed. The welcome screen 1200 allows the family member to access various functions and services provided by the web-based networking platform. For example, the photos and/or videos can be downloaded or streamed. The streaming video or photos can be displayed in the main frame 1202 of the welcome screen 1200. In addition, photos, videos, documents can be uploaded. In one embodiment, photos and/or documents can be scanned and uploaded on to the local server or the centralized server. Similarly, messages and reminders can be sent to other subscribers of the service and/or other subscribers linked to the family member in the networking platform.

For example, the family member may wish to send the care receiver a reminder to a Birthday party, or a reminder to a doctor's appointment. Incoming messages/emails can be displayed on the main frame 1202, when the message/email is received, or when the family member (e.g., by clicking a button) to read the message/email. In one embodiment, the user can access an online calendar to submit entries using the ‘UPDATE CALENDAR’ button. The online calendar can be shared with other subscribers, for example, subscribers that are on the care receiver's friend list. The care receiver can also select who can access the calendar on an individual basis. Events on the calendar can be made public or private individually as well. In one embodiment, the family member can have controlled access to submit entries into the care receiver's calendar.

In one embodiment, the family member can request that the care receiver measure vital signs and submit the results to the family member. The request may be transmitted in the form of a message and received by the care receiver through the networking platform. In some embodiments, when the vitals have been submitted, the family can be notified, via the online platform, or receive an alert via another device, for example but is not limited to, a cell phone or a pager. In one embodiment, the family member can ask the system to detect the motion of a care receiver, instantaneously, or over a period of time. A motion detector module may thus be activated on a client device used by the care receiver and respond back once the requested action is completed. The screen 1202 can alert the user once a response has been received, regarding the detected motion, or lack of motion of the care receiver.

Depending on the identity (e.g., care receiver, family member, or health care provider) of the user accessing the web-based networking platform, different services can be provided, as indicated by the functions available on the welcome screen, for example. The example of screenshot 1210 illustrates that a health care provider can change/request an appointment through the web-services. In addition, the health care provider can place a request to the care receiver (“Patient Dolly”) for a brief home visit.

The health care provider (e.g., primary care physician) may access patient records through the web-service. Similarly a pharmacist for example, may utilize the ‘UPDATE PRESCRIPTION’ button to send a message to the care receiver, indicating that a new prescription has arrived and is ready for pickup, for example. Since a health care provider is in some instances, not expected to share image data with a care receiver, a main frame for displaying images and/or videos is not shown in this example. However, in some embodiments, a main frame for displaying videos and images is included on the welcome screen for a health care provider.

Note that one or more buttons shown on the example screenshots 1200 and 1210, and the screenshots illustrated in other figures in this application, can and are expected to be linked to a webpage with a different screen layout, depending on the services selected. Additional screens with different screen layouts are contemplated and considered to be in accordance with the techniques and embodiments disclosed herein to provide the general functionality and services related to facilitating interactions between an elderly and caregivers.

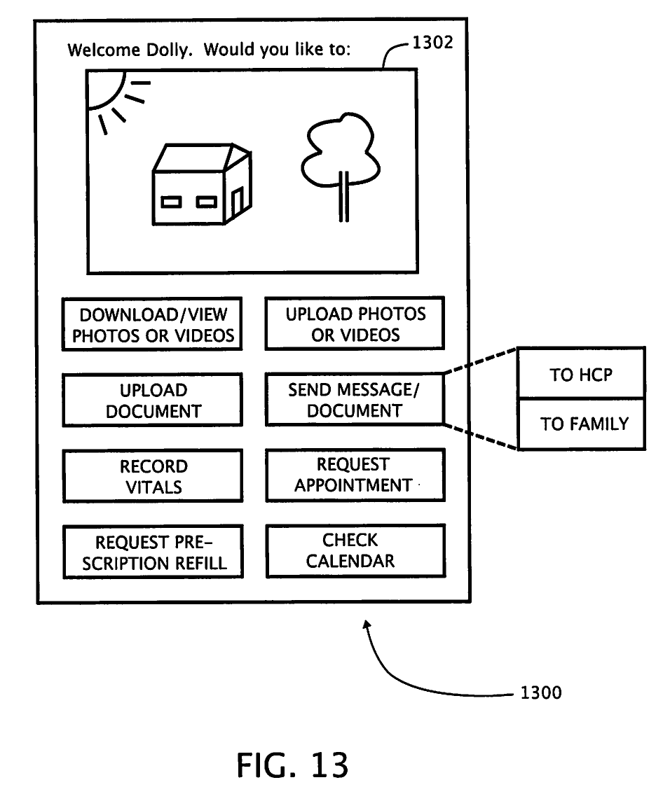

FIG. 13 illustrates a screenshot 1300 of a welcome page for a service subscriber to communicate with a family member or health care providers, according to one embodiment.

A welcome screen for a care receiver (“Grandma Dolly”) is illustrated in the example screenshot 1300 of FIG. 13. The welcome screen in the example includes a main frame 1302 for which information and images can be displayed. The welcome screen 1300 allows the care receiver to access various functions and services provided by the web-based networking platform. For example, the photos and/or videos can be downloaded or viewed as a streaming video. The streaming video or photos can be displayed in the main frame 1302 of the welcome screen 1300. In addition, photos, videos, documents can be uploaded. In one embodiment, photos and/or documents can be scanned and uploaded on to the local server or the centralized server. Similarly, messages and reminders can be sent to other subscribers of the service and/or other subscribers linked to the care receiver in the networking platform. Incoming messages/emails can be displayed on the main frame 1302, when the message/email is received, or when the care receiver (e.g., by clicking a button) to read the message/email.

In one embodiment, the care receiver can request an appointment with one or more health care providers via the web-interface. By selecting the ‘REQUEST APPOINTMENT’ button, several options related to the appointment can be provided to the care receiver, including which doctor to see, and what time to request the appointment for. The request can then be sent to the health care provider and an alert can be received via the web-interface when a response has been provided by the health care provider.

The alert can similarly be received via any device, such as, but is not limited to, a telephone, a cell phone, a pager, etc. In a similar manner, the care receiver can place a request to a pharmacy for a prescription refill. The care receiver can also, through the web-interface, access a calendar to submit new entries or to check the agenda for the day, week, and/or month. In some embodiments, the care receiver can access (with or without an authorization procedure) the calendar of another subscriber (e.g., a family member) to determine availability to attend an event, for example. In addition, the care receiver can request that another subscriber (e.g., a family member)

Events on the care receiver's calendar may or may not have privacy settings. The privacy settings can depend on the identity of the subscriber accessing the care receiver's module. For example, an entry indicating a doctor's appointment may be available for access by a family member and a health care provider, whereas an entry for a birthday party of a family member may not be accessible by a health care provider.

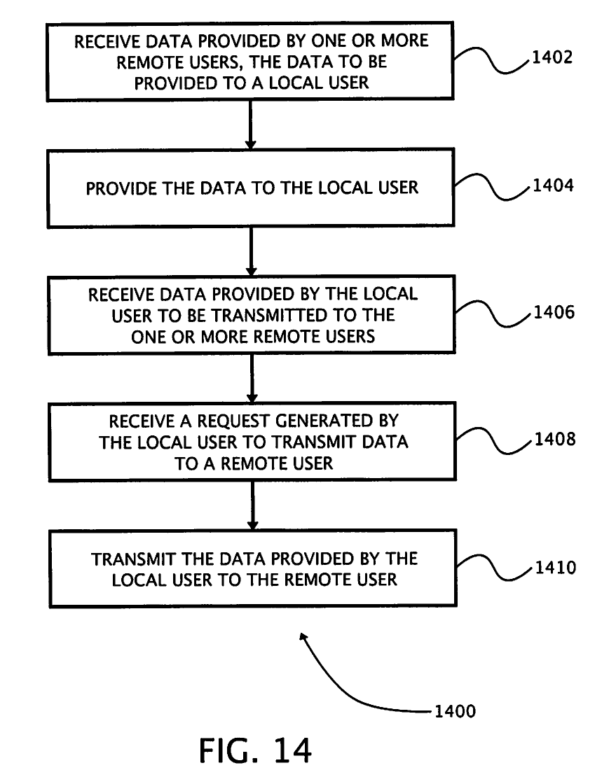

FIG. 14 depicts a flow chart 1400 of a process for facilitating interactions between an elderly and caregivers via an online networking platform, according to one embodiment.

In process 1402, data provided by one or more remote users is received. The data, in most instances is to be provided to a local user. The local user may be an elderly or aging individual who lives alone or with another aging partner at home. The one or more remote users, in most instances, can include, but is not limited to family members and/or health care providers of the elderly and/or the aging partner of the elderly. The data can be provided by the remote users via a web-interface. In one embodiment, the web-interface is similar to that of an online networking platform. The data uploaded by the remote user can be accessed via the web-interface, and the data can be transmitted to the local user, via the user interface of the networking platform.

In process 1404, the data is provided to the local user. In one embodiment, the data is provided to the user via a web-interface. In some embodiments, data can be provided to the local user in real-time as the data is being provided by the remote users. In one embodiment, data can be provided to the local user at pre-determined instants in time. For example, when the local user logs in to the web service, an icon may indicate that a new item has arrived. The local user can choose to view the item/object by, for example clicking on the icon. The data provided by the local user can include, but is not limited to, image data, voice data, video data, and textual data. In some embodiments, the textual data includes a set of medical records, a document, a text message, a set of instructions, an alert, contact information, a reminder, and/or a calendar event.

In process 1406, data provided by the local user is received and is to be transmitted to one or more remote users. In one embodiment, the data provided by the local user includes data including vital signs of the local user, such as, by way of example, but is not limited to, pulse rate, blood pressure, respiratory rate, spirometric data, body temperature, glucose level, oxygen saturation level, and intracranial pressure. The data having the vital signs of the local user can be recorded or received from a measurement over a network connection. In one embodiment, data including regarding the detected motion of the local user is recorded and an alert is generated when motion of the local user has not been detected for a pre-determined period of time.

In process 1408, a request generated by the local user to transmit data to a remote user is received. Similarly, the request can be generated via a web-interface, accessible to subscribers of the web-service. The request can also be generated from a portable device, such as by sending a USSD, an SMS and/or MMS message, via a cellular phone, for example. The request may be triggered by sending an email to a pre-determined email address. Other methods of identifying a request are contemplated and do not deviate from spirit of the novel art of this disclosure. In process 1410, the data provided by the local user is transmitted to the remote user. The data can be transmitted to the remote user via a network interface. The network interface can include, but is not limited to one or more of an internet connection, an extranet connection, a LAN connection, a telephonic connection, a 3G connection, a WAN connection, and a Bluetooth connection.

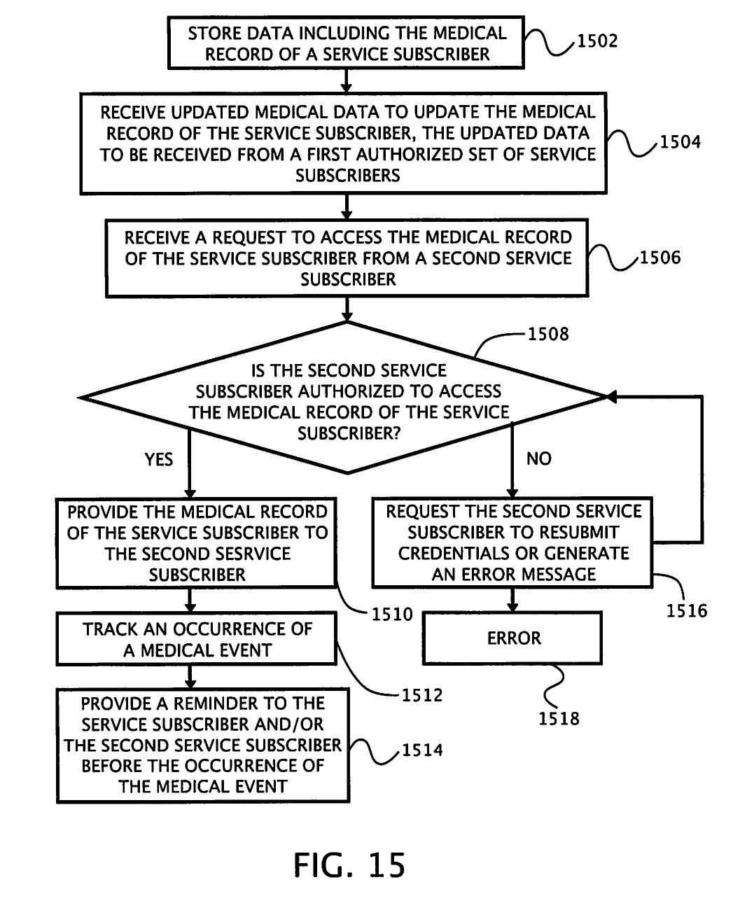

FIG. 15 depicts a flow chart 1500 of a process for medical records management, according to one embodiment.

In process 1502, data including medical records of a service subscriber is stored. The service subscriber can be any individual signed up for the medical records management services. For example, the service subscribers can be signed up by paying a service fee, that is monthly based, yearly based or usage based. The service subscribers may also be accessing the service on a trial basis. Regardless of the nature of the subscription basis, data including medical records of the service subscriber can be provided to the records management system in one or more of many ways. Medical records can be manually submitted into the system. For example, the system may provide a set of forms for different types of clinical visits, such as, ophthalmology, dentist, annual physical exam, orthopedics, etc. Custom forms may also be available.

In one embodiment, medical records are scanned and uploaded to a local drive and/or to a centralized server, managed by the records management service. The medical records can be uploaded by the service subscriber, by the doctor's clinic, and/or by the pharmacy, for example, automatically or manually. Further, the medical records can be uploaded by family members of the subscriber. Similarly, hospital, clinics, pharmacies, emergency rooms can be institutional subscribers, thus the records management service can be made available to the employees of a subscribed institution. In some embodiments, individual heath care providers and family members of a service subscriber can automatically be granted, for example, a ‘visitor status’ to the service for the purposes of accessing and updating medical records of the service subscriber, without subscribing. In other embodiments, health care providers and family members of the service subscriber may require a subscription to access and update medical records of the service subscriber.

In some embodiments, medical records stored locally and/or on a centralized server are encrypted to prevent unauthorized access to medical records due to data theft, data loss, loss of hardware, network hackers, etc. to comply with HIPAA (Health Insurance Portability and Accountability Act) standards, which establishes regulations for the use and disclosure of Protected Health Information (PHI). One or more encryption algorithms can be employed, including, but not limited to, DES, Triple DES, RSA, Blowfish, Advanced Encryption Standard (AES), CAST-128, CAST-256, Decorrelated Fast Cipher (DFC), Tiny Encryption Algorithm (TEA), eXtended TEA (XTEA), Corrected Block TEA (XXTEA), and/or RC5, etc

In process 1504, updated medical data to update the medical record of the service subscriber is received. The updated data, in one embodiment, can be received from a first authorized set of service subscribers. Similarly, updated medical records of the service subscriber can be received from the service subscriber in one or more of many ways, and from any authorized party including but not limited to family members, individual health care providers, and/or health care agencies/institutions.

In process 1506, a request to access the medical record of the service subscriber is received from a second service subscriber. In process 1508, the medical records management system determines whether the second service subscriber is authorized to access the medical records of the service subscriber. Whether the medical records are uploaded or accessed, automatically or manually by a third party, the system performs authorization and authentication procedures of the institution or individual uploading information, to ensure that data is submitted from or accessed by a health care agency and/or family member that are authorized to access the service subscriber's medical information.

Any known or convenient authorization and/or authentication procedure can be contemplated and do not deviate from the novel art of the disclosure. For example, records management system can employ a password authentication system, smart card, digital certificates, and biometric identification. Any combination of security authentication methods can be used.

In process 1510, the second service subscriber is determined to be authorized to access the medical record of the service subscriber, thus, the medical records of the service subscriber are provided to the second service subscriber. The records management system, in some embodiments, tracks the updated medical data and organizes the updated medical data. Therefore, for example, when a primary care physician wishes to access records pertaining to a service subscriber's visits to the cardiologist, an organized set of diagnosis and treatments related to the service subscriber's cardiac state could be retrieved.

In some embodiments, the medical records management system processes and analyzes the collective medical information received from the one or more authorized parties. If an anomaly is identified based on such data analysis, the system can automatically send a message or alert to the relevant parties, such as a family member and/or a physician. In other words, in some embodiments of the records management system, in addition to document and data management features, medical diagnosis and screening functions may be built in. For example, the system may identify several symptoms of the service subscriber as being indicative of a more serious disease and generate a report acknowledging various interested parties.

Other features and functionalities related to and can be derived from collective medical records management to provide medical diagnosis, treatment, and/or screening are expected and contemplated implications of which do not deviate from the spirit of the novel art of this disclosure.

In process 1512, an occurrence of a medical event is tracked for the service subscriber. The medical event may be one or more of an appointment with a health care provider and a scheduled intake of medication. In one embodiment of the medical records management system, the service subscriber and/or the health care providers and family members can enter/submit information into the system regarding scheduled health care events, such as, but are not limited to, doctor's appointment, annual physical exam, X-ray, blood test, eye exam, medication, instructions associated with medication, exercise regime, diet regime, vitamin intake, prescription refills, etc.

Therefore, reminders can be provided to the subscribers and/or their caregivers when the medical event is coming up, for example, at a pre-determined time before the event is to occur. The pre-determined time may be adjustable by the service subscriber and/or by the doctor for which the appointment is for, for example. In process 1514, a reminder is provided to the service subscriber and/or the second service subscriber before the occurrence of the medical event. For example, if the subscriber's son is to take the subscriber to his cardiologist next week, a reminder can be provided to the son as well.

However, in the event that the second service subscriber is determined to be unauthorized to access the medical records of the service subscriber, in process 1516, the medical records management system requests the second subscriber to resubmit logon information and/or other forms of credentials and the logon information is re-evaluated in process 1508. After a pre-determined number of invalid logon submissions, an error message is generated, in process 1518.

Although embodiments have been described with reference to specific example embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method of an interactive platform, the method comprising:
managing a set of calendar events of the care receiver, the set of calendar events of the care receiver to be submitted by one or more of the care receiver a caregiver;
generating a reminder associated with an upcoming occurrence of a calendar event of the set of calendar events at a predetermined amount of time prior to the upcoming occurrence, the reminder to be provided to one or more caregivers;
updating a status of one or more of the set of calendar events based on an update provided by one or more of the care receiver the caregiver;
identifying the schedules of the one or more care givers; and
identifying at least one responsible caregiver to manage a calendar event of the care receiver by comparing the schedules of the one or more care givers with the set of calendar events.

2. The method of claim 1, further comprising managing the schedules of the one or more caregivers.

3. The method of claim 1, further comprising identifying the schedules of the one or more caregivers via placing a request to the one or more caregivers to provide the schedules.

4. The method of claim 1, wherein at least a calendar event of the set of calendar events comprises a medical event.

5. The method of claim 4, wherein the medical event comprises an appointment with a health care provider.

6. The method of claim 5, wherein the medical event comprises a medication intake reminder.

7. The method of claim 1, wherein the status of one or more of the set of calendar events includes one or more of, completed, in progress, to be completed by a predetermined time, one or more caregivers who are responsible for supervision, and on hold.

8. The method of claim 7, wherein the status of the one or more calendar events includes miscellaneous notes regarding the one or more calendar events, the miscellaneous notes to be submitted by the care receiver and the one or more caregiver.

9. The method of claim 1, wherein the reminder is provided via one or more of, an instant message, an email message, a calendar alert, a pop-up screen, a telephone call, an SMS text message, and/or an MMS message.

10. A machine-readable medium embodying instructions, the instructions, which when executed, causing a machine to perform a method comprising:
managing a set of calendar events of the care receiver, the set of calendar events of the care receiver to be submitted by one or more of the care receiver a caregiver;
generating a reminder associated with an upcoming occurrence of a calendar event of the set of calendar events at a predetermined amount of time prior to the upcoming occurrence, the reminder to be provided to one or more caregivers;
updating a status of one or more of the set of calendar events based on an update provided by one or more of the care receiver the caregiver;
identifying the schedules of the one or more care givers; and
identifying at least one responsible caregiver to manage a calendar event of the care receiver by comparing the schedules of the one or more care givers with the set of calendar events.

11. A method of a family-oriented networking platform, the method comprising:
storing content related to the care receiver submitted by the care receiver, the content to be shared with a set of authorized users of plurality of registered users of the web-based networking platform;
receiving a request to access the content by a user of the plurality of registered users;
determining if the user is one of the set of authorized users of the plurality of registered users to access the content; wherein the set of authorized users to access the content submitted by the care receiver for a pre-determined amount of time;
providing the requested content to the user of the set of authorized users;
storing content related to the care receiver submitted by one or more of the set of authorized users;
wherein the content related to the care receiver to include one or more calendar events and reminders; and
facilitating interactions between the set of authorized users via the networking platform to provide a channel to delegate and manage responsibilities associated with the one or more of the calendar events and reminders for the care receiver.

12. The method of claim 11, wherein the set of authorized users are caregivers of the care receiver.

13. The method of claim 12, wherein the caregivers are one or more of family members of the care receiver and health care providers of the care receiver

14. The method of claim 11, wherein the content includes at least one of a textual data, image data, animation data, audio data, flash media, and video data.

15. The method of claim 11, wherein the one or more calendar events comprise a doctor's appointment.

16. The method of claim 11, wherein the reminders comprise a reminder for the doctor's appointment.

17. The method of claim 11, wherein the one or more of the calendar events and the reminders are submitted by one or more of the caregivers of the care receiver.

18. The method of claim 11, further comprising facilitating interactions via providing message sending and receiving functions in the networking platform.

19. The method of claim 18, further comprising providing an interactive calendar accessible via the networking platform by one or more of the caregivers of the care receiver.

20. The method of claim 19, further comprising managing the interactive calendar and updating the one or more of the calendar events submitted by the care receiver and the one or more of the caregivers.

21. The method of claim 20, further comprising providing a status indicator associated with a calendar event on the interactive calendar, the status indicator to indicate whether a caregiver has assumed responsibility for the calendar event.

22. The method of claim 21, wherein the status indicator be update-able in real-time.

23. The method of claim 11, wherein the content to include, one or more of, emergency contacts, insurance policies, manuals for medical devices, and prescriptions.

24. A machine-readable medium embodying instructions, the instructions, which when executed, causing a machine to perform a method comprising:
storing content related to the care receiver submitted by the care receiver, the content to be shared with a set of authorized users of plurality of registered users of the web-based networking platform;
receiving a request to access the content by a user of the plurality of registered users;
determining if the user is one of the set of authorized users of the plurality of registered users to access the content; wherein the set of authorized users to access the content submitted by the care receiver for a pre-determined amount of time;
providing the requested content to the user of the set of authorized users;
storing content related to the care receiver submitted by one or more of the set of authorized users;
wherein the content related to the care receiver to include one or more calendar events and reminders; and
facilitating interactions between the set of authorized users via the networking platform to provide a channel to delegate and manage responsibilities associated with the one or more of the calendar events and reminders for the care receiver.

25. A system, comprising:
means for, storing content related to the care receiver submitted by the care receiver, the content to be shared with a set of authorized users of plurality of registered users of the web-based networking platform;
means for, receiving a request to access the content by a user of the plurality of registered users;
means for, determining if the user is one of the set of authorized users of the plurality of registered users to access the content; wherein the set of authorized users to access the content submitted by the care receiver for a pre-determined amount of time;
means for, providing the requested content to the user of the set of authorized users;
means for, storing content related to the care receiver submitted by one or more of the set of authorized users;
wherein the content related to the care receiver to include one or more calendar events and reminders; and
means for, facilitating interactions between the set of authorized users via the networking platform to provide a channel to delegate and manage responsibilities associated with the one or more of the calendar events and reminders for the care receiver.
